(19) United States
(12) Patent Application Publication
(10) Pub. No.: US 2024/0300171 A1
(43) Pub. Date: Sep. 12, 2024

(54) A THREE-DIMENSIONAL PRINTING AND FINISHING DEVICE FOR FORMING AND FINISHING A CURABLE CONSTRUCTION MATERIAL

(71) Applicant: James Lyman Reusch, Salt Lake City, UT (US)

(72) Inventor: James Lyman Reusch, Salt Lake City, UT (US)

(21) Appl. No.: 18/551,516

(22) PCT Filed: Feb. 28, 2022
(86) PCT No.: PCT/US22/18176

§ 371 Date: Sep. 20, 2023

(51) Int. Cl. B29C 64/194; B28B 1/00; B28B 11/08; B29C 64/209; B29C 64/236; B29C 64/241; B29C 64/393; B29K 63/00; B29K 105/04; B33Y 30/00; B33Y 40/20

(52) U.S. Cl. CPC B29C 64/194; B28B 1/001; B28B 11/0845; B29C 64/209; B29C 64/236; B29C 64/241; B29C 64/393; B33Y 30/00; B33Y 40/20; B29K 2063/00; B29K 2105/04

(57) ABSTRACT

A three-dimensional (3D) printing and finishing device (100) and a method for forming and finishing a curable construction material to produce a 3D printed object. The 3D printing and finishing device (100) can include a structural support (102), a print head (104), and a finishing unit (116). The print head (104) can move to dispense a curable material in layers and the finishing unit (116) can align with a side of the dispensed layers and can modify a surface of the material. The finishing unit (116) can include a nozzle to dispense fluid toward the surface.

### FIELD OF THE INVENTION

The present disclosure relates to finishing devices and methods for modifying the appearance or qualities of a curable construction material which has been extruded by a 3D printer. Therefore, the disclosure relates to the fields of 3D printing, additive manufacturing of cementitious or curable materials, and the modification thereof.

### BACKGROUND

### Description of the Related Art

Construction has been a necessary and expansive industry for millennia, and particularly the construction of buildings using Portland Cement. However, the forming of cement utilizes many single use materials and forms. High labor costs are also required for the generation and finishing of cement or concrete-based structures. The design and use limitations of concrete have long been implicitly understood, and the side effects of the curing process have also been a challenge when producing items, houses, and large structures. These limitations include, for example, the large amounts of single-use materials required, the difficulty and inability to form non-linear and/or rounded geometry features in designs, and the contribution of total greenhouse gas emissions and cost. Furthermore, the time and financial cost of teams of craftsman travelling to and from the work site, as well as the waiting time in between steps, has been an additional source of wasted resources and inefficiencies. Attempts to change construction processes have been made and benefits have been found using alternative construction techniques and experimenting with cement substitutes such as cementitious or curable materials.

In recent decades 3D printing, also called additive manufacturing, contour crafting, and stereo lithography, has become a prevalent technology used for rapid prototyping and manufacturing. Many variants for building and operating such 3D printers have been devised, and various unexpected printing materials have likewise been integrated into the 3D printing industry. One of the more promising, yet likewise challenging, is the printing of curable materials, and curable construction materials in particular. This technology has seen rapid development and many construction companies are pursuing better techniques and advances in the field. Small objects as well as homes and large structures built using 3D concrete printing have become a growing segment of the curable material printing space.

Methods for reducing labor or manpower, material waste, and the carbon footprint of printing with cementitious materials are constantly being pursued and many show promise.

### SUMMARY

A three-dimensional (3D) printing device in conjunction with a finishing device for forming and finishing a curable construction material to produce a 3D printed object can be implemented to improve the typical approach of 3D printing alone. The 3D printing and finishing device combination can typically have a structural support as part of the 3D printer. For extruding the curable material this support can have a print head suspended from the structural support. This head can be moveable along at least two axes with respect to the structural support. The print head can be configured to dispense the curable construction material in layers along a predetermined pattern to form the 3D printed object. For finishing of external surfaces of the material a finishing unit can be attached to the print head. The finishing unit can be disposed to align with at least one side of the layers of the curable construction material. The finishing unit can include at least one nozzle to dispense fluid toward the surface. The finishing unit can use the at least one nozzle to dispense a fluid to modify a surface of the at least one side of the layers of the curable construction material.

In another embodiment of the present technology the finishing unit may be built independent of the 3D printer used and may then attach to any 3D printer or device to print extruded material. The 3D printing finishing unit can be used with any three-dimensionally printed curable construction materials that have multiple layers which are stacked and have respective sides. The finishing dispenser unit can include a finishing housing capable of being aligned with at least one side of the layers of the curable construction material. The finishing dispenser unit can have at least one nozzle to dispense a fluid toward the surface. This can be done to modify the surface of the at least one side of the layers of the curable construction material prior to full curing such that surface contours of the construction material can still be manipulated.

In another embodiment of the present technology, a method of finishing a three-dimensionally printed curable construction material can include printing stacked layers of a curable construction material. This printing can be done in a predetermined pattern via a print head suspended from a structural support. A finishing unit can be attached to the print head. The finishing unit can include a finishing dispenser. The finishing dispenser can dispense a fluid from a nozzle toward the side of a printed layer. Multiple nozzles can be used to dispense on one or more layers of one or more sides of the printed material. The fluid can be used to modify at least one side of the printed layer.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side view of an exemplary 3D concrete printer with a printhead and a finishing device suspended therefrom.

FIG. 2 is a side view of the printhead of FIG. 1 showing the finishing device in closer detail with one example of the nozzles of the finishing device.

FIG. 3 is a side view of an alternative printhead with a finishing device suspended therefrom operable to modify multiple surfaces simultaneously.

FIG. 4 is a side view of a double portion wall and a printhead with a finishing device suspended therefrom.

FIG. 5 is a side view of an alternative printhead operable to print both parts of double portion walls simultaneously and with a finishing device suspended therefrom.

FIG. 6 is a side view of an alternative finishing device with a texture wheel.

FIG. 7 is a side view of an alternative finishing device with a stamping device.

FIG. 8 is flow chart showing an exemplary method for finishing a single layer in multiple passes.

These drawings are provided to illustrate various aspects of the invention and are not intended to be limiting of the scope in terms of dimensions, materials, configurations, arrangements, or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

As used herein, “curable material” refers to materials which cure over a period of time due to a chemical reaction, due to the effects of drying, due to exposure to a catalyst such as light or a chemical such as retardants or accelerants, or any combination thereof. Although curing can include merely drying, in some cases curing can be a chemical process employed in polymer chemistry and process engineering that produces the toughening or hardening of a polymer material by cross-linking of polymer chains. Curable material is distinct from instantly finished material in that it provides a non-instantaneous period where the material is not fully set or hardened. Curing times can generally range from several minutes to several days, depending on the type of material, composition including additives, thickness of the curable materials, ambient conditions of temperature and humidity, etc.

As used herein, “curable construction material” refers to curable materials which are used in construction applications. These applications result in small objects, houses, commercial buildings, or other large structures. A typical example of such a material is Portland cement, though mortars and concretes are also curable construction materials. Alternate materials which are also non-limiting examples of such include geopolymer, geocrete, hempcrete, epoxy, foam, cement, cementitious materials, clay, mud, and other concrete substitutes that have qualities allowing them to be extruded and used as structural elements in construction.

As used herein, “suspended” means attached or disposed on a supporting structural member. In some embodiments this structural member can be one or more of a gantry, a boom, a robotic arm, a system of ropes and pulleys, or any suitable member of a 3D printer upon which a print head may be disposed to allow the extrusion of the curable construction material at desired and predetermined variable spatial locations.

As used herein, the terms “print” and “extrude” may be used interchangeably and refer to extruding the curable construction material from the print head of the 3D printer.

As used herein, the term “dispense” will only be used to refer to the finishing device dispensing a fluid or other matter, as opposed to the print or extrusion of construction material from the primary print head.

The singular forms “a,” “an,” and “the” include plural referents unless the context clearly dictates otherwise. Thus, for example, reference to “an additive” includes reference to one or more of such materials and reference to “dispensing” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Examples of the Technology

Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

With the general examples set forth in the Summary above, it is noted in the present disclosure that when describing the system, or the related devices or methods, individual or separate descriptions are considered applicable to one other, whether or not explicitly discussed in the context of a particular example or embodiment. For example, in discussing a device per se, other device, system, and/or method embodiments are also included in such discussions, and vice versa.

Furthermore, various modifications and combinations can be derived from the present disclosure and illustrations, and as such, the following figures should not be considered limiting.

### A Device for 3D Printing a Curable Material and Real Time Finishing

Three-dimensional (3D) printing is an increasingly common technology that has proven useful in many manufacturing fields, particularly due to the rapid-build aspects common to printing with plastic and similar materials. However, in printing areas involving other materials, particularly those which require non-immediate curing times, there are many hurdles which limit the adoption of 3D printing.

The field of 3D concrete printing in particular has steadily seen the promised functionality of the technology be hindered by unwieldy machinery which inhibits real-world applications, as well as curing speed and stability issues which result in structures or buildings that are not structurally stable or require additional curing time between printing of individual layers.

Even in curable material extrusion systems that are able to print continuously and maintain minimum strength requirements, the need to utilize manpower and additional tools or machinery to finish the resulting concrete structures minimizes the time and cost-saving benefits of the technology.

Whereas a plastic-based 3D printer is typically unable to shape the extruded plastic after initial printing due to the near-instant setting speeds, mediums such as concrete typically require longer curing times before the structures are no longer alterable or are ultimately fully-cured and strengthened. This creates an opportunity to finish or smooth the surfaces which have been printed, but also the necessity to have workers engage in such finishing in the absence of an automated process to carry out the finishing.

In accordance with the present technology, the print head of the 3D printer can be supplied with tools and devices which work in tandem with the 3D printer and its movements to finish exterior surfaces of the extruded concrete.

The present technology provides a three-dimensional (3D) printing and finishing device for forming and finishing a curable construction material to produce a 3D printed object. In further embodiments, the present technology also extends to a 3D printing finishing unit for use with three-dimensionally printed curable construction materials, and methods of finishing a three-dimensionally printed curable construction material. Three-dimensional (3D) printing devices can include gantry style printers, robotic arm printers, boom-based printers, cylindrical rotating disk printers, pulley and rope printers, drone-based printers, or any combination thereof, for example a gantry with a robotic arm mounted on it.

The 3D printer may be large or small scale and can be suited to printing with any curable material. The curable material can be any curable material which can be extruded to form a structure, and which requires a non-instantaneous curing period, or a curing process requiring a catalyst, such as UV radiation or a chemical. The material directly adjacent and leaving the print head that is currently being printed is referred to as a print bead.

The 3D printing and finishing device can be any type of printer such that it has a structural support member upon which a print head may be suspended. In the case of a gantry printer, the structural support can be affixed to the gantry or be free moving. In the case of a robotic arm printer, the final segment of the arm can serve as the structural support. Any 3D printer can be utilized so long as the print head is capable of moving along at least two axes (e.g. X and Z) with respect to the structural support, and in some cases along three axis (e.g. X, Y and Z). Typical 3D printers allow printing in 3D spaces via a combination of movements of printer elements or the movement of the printer itself, or coordinated movement of the printer elements and movement of the printing surface, and any such 3D printer device should prove suitable.

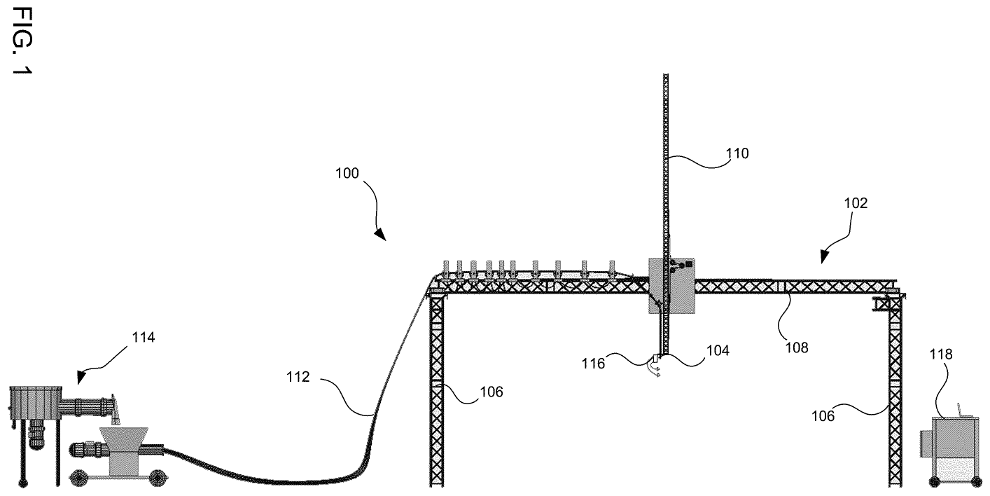

Referring to FIG. 1, a 3D printing and finishing system 100 can include a structural support 102 from which a print head 104 is suspended. In this case, the structural support 102 includes a set of vertical supports 106, a primary horizontal support 108, and a vertical beam 110. The print head 104 can be movably secured to the vertical beam 110. The vertical beam 110 can be movably secured to the primary horizontal support 108 to allow for movement of the print head 104 in a first horizontal direction parallel to the orientation of the horizontal support 108. The horizontal support 108 can also be movably secured to the vertical supports 106 to allow the horizontal support 108 (and thus the print head 104 attached to the horizontal support 108) to move in a second horizontal direction that is perpendicular to the first horizontal direction (i.e. in a direction perpendicular to the orientation of the horizontal support 108 within a horizontal plane defined by the horizontal support 108). The print head 104 can move vertically as the vertical beam 110 of the structural support 102 moves vertically. A delivery hose 112 carries curable construction material to the printhead 104. The delivery hose 112 is connected to a pump and mixer 114. The print head 104 can also be provided with a finishing unit 116. The 3D printing and finishing system 100 can be controlled electronically such as via a computer system 118 which can be connected to the mixer 114, print head 104, and/or control motors wirelessly or via wired cables.

The movement of the elements of a 3D printer can allow the print head 104 to dispense the curable material in layers along a predetermined pattern. This movement and dispensing process allows the 3D printer and finishing system 100 to form the 3D printed objects, the pattern of which is typically controlled by a software process. Any software process which enables a pattern to be printed by a 3D printer is viable, and one having ordinary skill in the field of 3D printing would be able to implement the software process to enable the printing. Layers of curable material dispensed by the print head 104 have a number of sides which can be orthogonally oriented to the direction of the printing. Depending on the orientation of the printing and the direction of movement, one or more sides may be accessible.

As mentioned above, the print head 104 of the 3D printer and finishing system 100 can have a finishing unit 116 attached to it. The finishing unit 116 can be positioned to align with at least one side of layers of printed material. The finishing unit 116 can be configured to dispense a fluid to modify the surface of the at least one side of the layers. The finishing unit 116 can include at least one nozzle to dispense the fluid toward the surface. As used herein, the term “modify” can include finishing, flattening, embossing, etching, cutting, cross-hatching, shaping, creating patterns, coloring, reshaping, stamping, depositing, texturing, and forming.

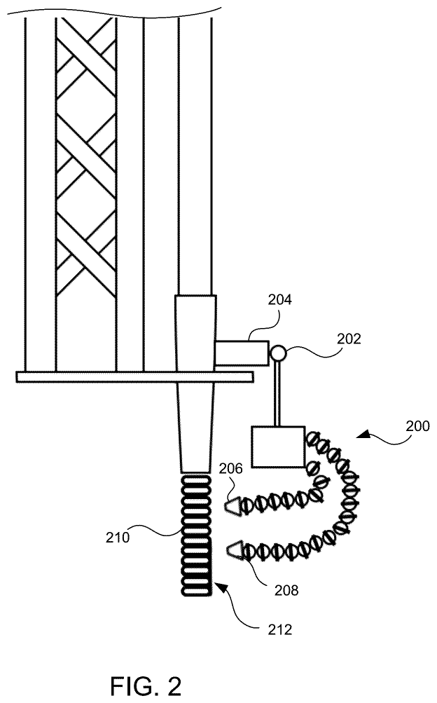

FIG. 2 is a side view of an exemplary print head and finishing device. A finishing device, such as finishing unit 200 can be used to smooth, modify, or otherwise finish surfaces of the printed layers of the curable construction material 210. Typical smoothing/finishing processes can either require additional material or can smooth and/or shape curable construction material directly without additional material. With a process that uses additional material, the additional material can be spread on a cured or partially cured surface of curable construction material and can then be smoothed with trowels, sanding, or the like. With concurrent or real-time smoothing, the curable construction material itself can be smoothed. This occurs while the curable construction material is still in the curing process without adding additional material. Both options are traditionally carried out by hand. However, smoothing the wall itself rather than adding material can reduce the total material used.

In cases where the printing results in a vertical wall, it is common for a “sausage” shape to result. This shape can be defined where a width of an adhesion area between each successive layer is narrower relative to a maximum width of each layer. Or in other words, the layers have a wider material width at the vertical midpoint of each layer as compared to a material width at a top and a bottom of each layer. The resulting pattern of the wall resembles a series of sausages laid out horizontally and stacked vertically.

When printing results in such a pattern, or in other applications using printed or non-printed curable construction materials, it can be desirable to flatten, smooth, or otherwise finish the extreme width points of each layer. The examples discussed herein provide methods and devices for flattening, smoothing, and/or finishing the surface of printed wall using a finishing device.

Referring again to FIG. 2, a finishing unit 200 can include a print head attachment mechanism 204 to secure the finishing unit 200 to the print head 204. A nozzle 206 can also be fixed to the finishing unit 200 and oriented to dispense a fluid towards the printed curable construction material 210 printed by the printhead 204. In the embodiment shown in FIG. 2, the nozzle 206 is accompanied by a second nozzle 208. However, more than two nozzles can also be incorporated into the finishing unit 200. The dispensed fluid from the nozzles 206, 208 can modify the curable construction material 210, such as to perform a finishing step on the curable construction material. In the embodiment shown in FIG. 2 the nozzles 206, 208 are oriented to dispense toward the vertical side surface of the printed curable construction material 210, but they may be oriented in any direction or angle to modify any surface of the printed curable construction material 210. In this manner after one or more layers of printing is completed, the finishing unit 200 can be used to finish a horizontal surface, such as the horizontal surface of the final printed layer.

In one example, the nozzles 206, 208 can each be configured to align with one of the layers of the curable construction material 210. This allows for the nozzles 206, 208 to modify the layer of the printed material 210. In a further example, the nozzles 206, 208 can be configured to align with multiple layers and are thus able to modify the surfaces of adjacent successive layers. For example, one nozzle may be aligned to focus on one layer but provide overspray on the neighboring layers. In another example, the nozzle may be aligned to modify two layers directly depending on the force of the dispensed fluid.

The uppermost layer which one of or both nozzles 206, 208 are aligned with may be the currently printing layer of the curable construction material 210. In such a case, the layer may require some lead distance between the print head 204 and the surface area being targeted by one or both of the nozzles 206, 208. The uppermost layer targeted by one or both of the nozzles 206, 208 may also be directly below the currently extruding layer, or some number of layers below the currently extruding layer as the curing time for the material used may dictate.

In another example, one of the nozzles 206 can be aligned with and/or oriented towards two or more layers of the printed curable construction material 210, while the other nozzle 208 can be aligned with and/or oriented towards one layer of the printed curable construction material 210. Similarly, one nozzle 206 can be aligned with and/or oriented towards one or more layers of the curable construction material 210, such as an uppermost layer and/or a layer directly below the uppermost layer, while another nozzle 208 can be aligned with and/or oriented towards one or more other layers of the curable construction material 210. Such alignment allows the nozzles 206, 208 to shape different printed layers on each subsequent pass of the print head and the finishing unit, or to allow the nozzles 206, 208 to provide shaping of the same printed layer to different degrees of completeness.

The size of the nozzle and fluid flow from the nozzle can be adjusted to provide a desired degree of reshaping upon impact with the surface. Depending on the curable material composition and cure rates, modification of the surface can occur over multiple passes. For example, a first finishing pass can provide a coarse adjustment while a second finishing pass can provide a finer flattening to form a more refined flat surface. Referring to the embodiment shown in FIG. 2, the nozzles 206 and 208 can be oriented toward separate layers of the printed curable construction material 210 to enable modification in different passes. In one example, the nozzle 206 can provide a coarse adjustment to a more recently extruded layer (e.g. a layer towards the top of the extruded curable materials), the nozzle 208 can provide a finishing pass over an older layer (e.g. a layer underneath more recently extruded layers).

In another example, the fluid can be dispensed from each of the nozzles 206, 208 to flatten the layers of the curable construction material 210. In this example, the nozzles 206, 208 can each be aligned with some number of layers of the printed curable construction material 210. The nozzles 206, 208 can act to modify the layers of printed curable construction material 210 and in each pass can further flatten the curable construction material 210 to form a flattened or modified region 212. In such an embodiment, the end goal can be to flatten any bulging surfaces of the extruded portions of each surface. When using multiple vertically spaced nozzles, each nozzle can have the same fluid pressure and flow rate, or can be independently adjusted.

In another example, the nozzles 206, 208 can be operable to remove material from the layers of the printed curable construction material 210. For example, the nozzles 206, 208 may be oriented to cut away or otherwise take off material from wide points of the layers of the printed curable construction material 210. In this example, the nozzles 206, 208 can be oriented at an angle with respect to the layers of the curable construction material 210, or can be oriented or pointed vertically with respect to the layers of the curable construction material 210 to remove material from the printed layers of curable construction material 210.

In one embodiment, the layers can be printed and have some determined number of intermediary layers which are allowed to cure partially. Then a first nozzle, such as nozzle 206, can be targeted at a first layer under the number of intermediary layers to be modified. Simultaneously a second nozzle, such as nozzle 208, can be targeted at a second layer which can be a layer underneath the layer targeted by the first nozzle. Thus, a layer can be finished to a target percentage of completion by the first nozzle in a first pass. Then, as one or more layers are added, the partially finished layer can become oriented further from the print head such that it is now targeted by the second nozzle. The second nozzle can further finish the layer. Any additional number of nozzles may be utilized to allow the finishing of a single layer to happen in steps such that it is ultimately finished, such as through flattening, to the desired, cumulative amount.

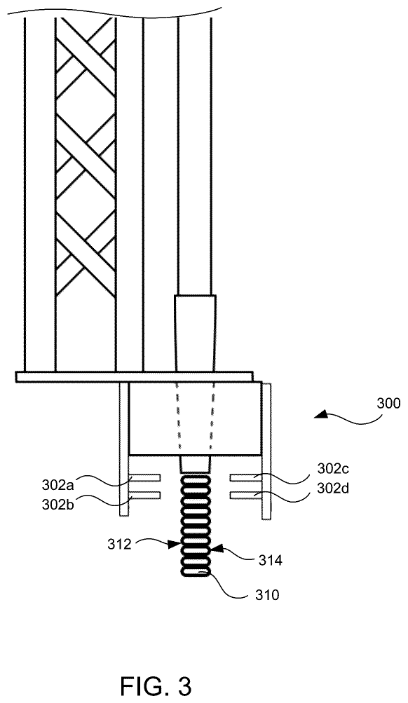

In FIG. 2, the finishing unit 200 includes nozzles 206, 208 that are operable to finish one side of the curable construction material 210. However, finishing units can be provided that finish more than one side of a curable construction material. FIG. 3 shows an example with a finishing unit 300 for finishing or otherwise modifying multiple surfaces of a curable construction material 310. The finishing unit 300 comprises first nozzles 302a, 302b that can be oriented toward a first side 312 of the printed curable construction material 310. The finishing unit can also comprise second nozzles, 302c, 302d that can be oriented toward a second side 314 opposite the first side 312 of the printed curable construction material 310.

In the above examples, walls that are created by the printed curable construction material are shown to be made of a single printed portion. However, it is possible that walls or other structures can be made up of two separate, parallel portions printed with a determined gap space in between. This method of printing allows for hollow walls with an enclosed cavity, much like traditional wooden construction where drywall and exterior wall portions encapsulate a hollow space. One benefit of such construction can be that a cavity is formed where piping and electrical wire can be placed. Additionally, this cavity can be filled with concrete or insulation for strength or insulating effects. In the traditional forming of solid concrete walls, this cavity is not usually made. However, with 3D printing of concrete or the like, single horizontal portion walls can be printed, or double portion walls with a cavity can be printed. Depending on the application, various advantages can be had by printing in this manner.

In a situation where a double or hollow wall is printed as described above, the double or hollow wall comprises interior surfaces that are surfaces facing each other defining the space or cavity of the double or hollow wall. The double or hollow wall further comprises exterior surfaces that are opposite each of the interior surfaces and that face away from the double or hollow wall. In this situation, it can be desirable to finish one or both the exterior surfaces of the double or hollow wall. In some instances, it can be desirable to finish the interior surfaces of the double or hollow wall.

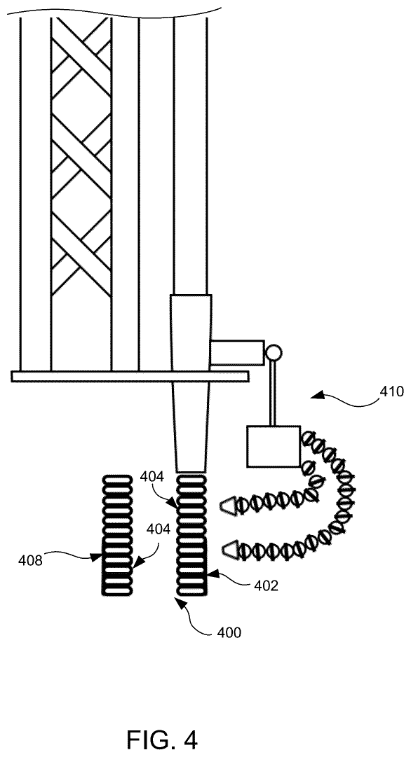

Referring to FIG. 4, a printed wall 400 can be a double portion wall as described above. The printed wall 400 can have a first exterior side surface 402, a first inner surface 404, a second inner surface 406, and a second exterior surface 408. A finishing unit 410, which can be similar to finishing unit 200 for example, is shown in FIG. 4 as being oriented towards the first exterior side 402. The finishing unit 410 can follow the path of printing such that it becomes oriented toward the second exterior surface 408. In the embodiment shown in FIG. 4, the interior surfaces 404, 406 can be left unfinished as they would not be visible in the completed structure. However, in another embodiment these interior surfaces 404, 406 can be finished as well.

In the examples described herein, the finishing unit (such as finishing units 200, 300, 410) can include sensors to measure a gap distance from the surface of the printed curable material. In some examples, a flow rate of the fluid dispensed by the finishing unit can be at least partially based on feedback from the position sensors. This allows for the finishing of the surface to be controlled by a computer algorithm and enables the finishing device to react in situations where the curing rate of the printed curable material changes due to environmental factors. These sensors can also be used to assist in finishing that results in more complex modifications such as patterns, embossed words, or cross-hatching.

In examples of a finishing unit described herein, a finishing unit can have one or more actuators to move the at least one nozzle relative to the surface. For example, the one or more actuators can be controlled based on the feedback from the position sensors. This allows for the nozzles to respond both to differing curing rates of the printed curable material, as well as to create more varied outcomes.

In some examples, the nozzles themselves can be placed or controlled to etch patterns into/onto the surface, such as cross-hatching, embossing words or initials, or any other conceivable pattern.

In one embodiment, the nozzles can be positioned manually and act without further control to shape, smooth, decorate, or create patterns. In another embodiment, the nozzles can be controlled by software and one or more actuators to change angles and pressure as desired to create more intricate results or expel materials in a controlled fashion.

In another example, the fluid dispensed by the finishing unit can be at least one of air and water. The proportion of air and water can allow for different outcomes and increases the techniques possible for modification of the printed material.

In another example, the fluid dispensed by the finishing unit can include a surface finish additive. This surface finish additive can provide at least one of a color, sheen, texture, curing function, or sealant to the at least one side of the layers of the curable construction material. Modification can include change in dimensions, acid activation, and extent of hydration, for example. A curing function can include accelerating, retarding, starting, or stopping the curing process. The one or more nozzles can be used to spray concrete curing or retarding materials. One such material can be a wax sprayed on the layers after a determined number have printed to control the curing speed of cement or concrete.

In another example, the surface finish additive can include glitter, salt, iron, paint, or silica. This allows for different surface results. This can include sparkle via glitter, pitting via salt, a rust effect due to iron, color changes via paint, and texture or reflective effects via silica.

The finishing device can use the glitter, salt, iron, paint, silica, and other materials for decoration. For example, glitter can be sprayed onto/into the cement surface, salt (normally the bane of concrete) can be sprayed onto the cement surface to cause a pitting effect/create texture, iron dust or pellets can be sprayed onto the surface to create a pattern of rust-like imprints, paint can be sprayed as one would expect of paint to decorate and alter color, and silica can be sprayed to create reflective properties. Any other material which might be sprayed by the nozzle could be used to create decorative or custom properties on the surface of the printed material.

In another example, the print head of the 3D printer can be a round print head to dispense the curable construction material, although other shapes such as serrated heads can also be used. Using a round print head, the print bead is likewise round, and this enables cornering and other directional changes without causing tangential distortion in the sides of the extruded material. The round print head can be fixed or rotatable, and the finishing unit can be rotatable around the print head or fixed as well.

Material extruded by any print head typically spreads evenly to fill as much space as possible. Different shaped print heads alter this spread, and some print heads coupled with different printing speeds can create very wide print beads and resultant layers.

Print heads of any shape can be utilized, and the distal end of the printhead can include patterns such as serration, waves, or gear-like teeth to provide additional finishing qualities to the printed layers. The pattern of the print head can also impact layer adhesion of the printed material. The print head used in any implementation of the printer and finishing device may be a round head which can be capable of printing in any axis without rotating the head. A round head can print a print bead that will extrude evenly when cornering or changing direction. In such a case, the finishing device can likewise not rotate, or can also rotate around the printhead so as to stay oriented toward the surfaces being targeted.

In another example, the print head of the 3D printer can be a rectangular print head. The rectangular print head can be rotatable along a vertical axis. The rectangular print head can be benefited by being rotatable along the axis perpendicular to the printing direction.

One result of rotation is the ability for the rectangularly shaped head to rotate when cornering, ensuring the outer side surface of the print bead remains on the outer side surface. Likewise, if the rectangular shape of the print head is used on corners without rotating, the width of the printed layer will change from one side dimension of the rectangular nozzle to the perpendicular side dimension, potentially creating a corner where the two adjacent sides are noticeably different in thickness.

The rotation of a rectangular nozzle can be similarly beneficial when printing layers which are not straight and that require constant thickness of the layer while moving in generally horizontal axes to produce curved, bowed, or wavy paths.

In a sample case where the print head is rectangular and rotatable, the finishing device can be affixed to match the rotation of the head or be deposed on the print head such that it can rotate independently.

In another example, the print head of the 3D printer can be rotated along one or more additional axes relative to the print head rather than to the structural support. Such rotation can facilitate printing in non-vertical directions, such as diagonally. Diagonal printing can be used to improve layering successive layers of printed material to build upon each other to create overhangs or even arches in the final printed object. Angled printing can facilitate adhesion between non-vertically oriented layers.

The print head of the 3D printer can be made of a split head that simultaneously dispenses the curable construction material in adjacent layers which are spaced apart a gap distance. Such printing enables the printer to print the horizontal layers of double portion walls in a single pass, reducing the overall print time. Such a print head can print both wall portions simultaneously, which allows the cavity or hollow portion of double portion walls to be created at the same time as well.

Another example of this split head may extrude layers with a minimal gap distance to increase wall thickness for single portion walls. Another example may be vertically oriented split heads to print a vertically adjacent set of layers.

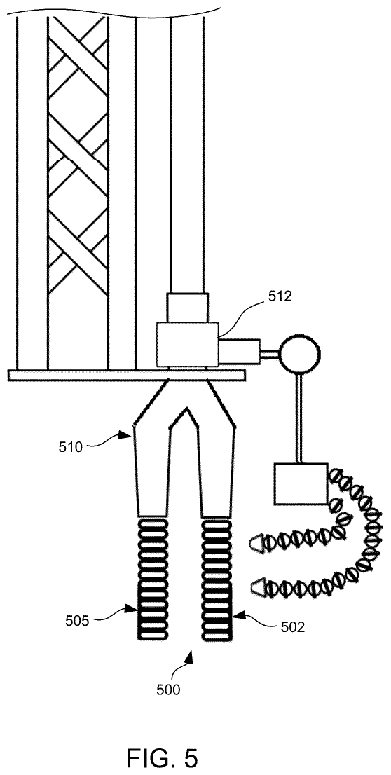

In an example like the above, the finishing device can be capable of targeting any of the sides of the printed layers and would be rotatable along with or independently of the print head. Referring to FIG. 5, a wall 500 made of printed curable construction material can have a first side wall 502 and a second side wall 504. A split print head 510 can print both the first side wall 502 and the second side wall 504 simultaneously. The print head 510 can be provided with a rotating device 512 to allow rotation of the print head 510 around corners and contours to maintain a consistent alignment with a direction of printing.

The curable construction material printed and finished by the 3D printer and finishing device can be at least one or more of concrete, a geopolymer, geocrete, hempcrete, epoxy, foam, cement, cementitious materials, clay, mud, and concrete substitutes that have concrete-like properties and can be used as structural material in construction. Various print materials can provide situation specific advantages over traditional Portland Cement, including strength, color, environmental resistance, and reduced carbon emissions. The utilization of such materials in 3D printing and finishing would be well known by one having ordinary skill in the field of curable materials and concrete replacement sciences.

The 3D printing and finishing device utilizes a curable material to print the structures being made, and the curable material may be any material capable of being extruded by the printer. When used for the printing of smaller objects such as pots, barbecues, or the like, various low-strength curable materials may be utilized. Likewise, when printing a home or structure stronger curable construction materials may be more suited for the task. The most common curable construction material is concrete or cement, typically of the Portland Cement variety.

However, many such curable construction materials have been developed and are currently growing in use and application. These often are designed to reduce the carbon emissions associated with cement. The 3D printer and finishing device may be used to extrude geopolymers, geocrete, hempcrete, epoxy, foam, cement, cementitious materials, clay, mud, and concrete substitutes. Utilizing these materials instead of concrete can provide environmental benefits, as well as potential cost and strength benefits to the printed structure. Finishing these materials using the finishing device is possible and the versatility of the printer and finishing device better enables customization of printing projects.

In another example, the finishing unit may be a pattern wheel oriented to engage the surface of the printed layers. The pattern wheel can include an embossed pattern which transfers to or creates a decorative pattern on the printed surface. This pattern may be any suitable pattern for stamping curable material, such as concrete stamps, or any other custom designs.

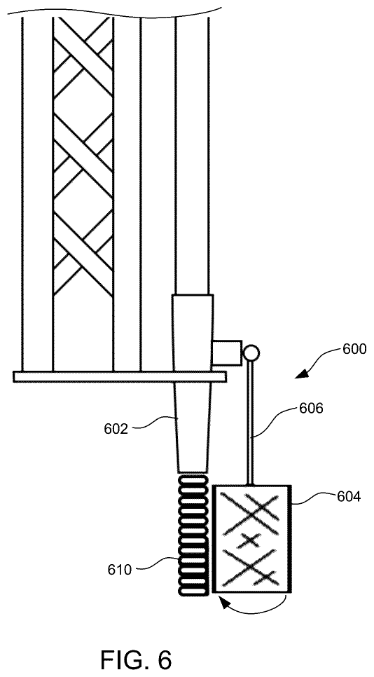

Referring to FIG. 6 a finishing unit 600 can be attached to a print head 602. The finishing unit 600 can be provided with a pattern wheel 604. The pattern wheel 604 can be attached with a connector 606 to the print head 602 to allow it to modify the printed curable construction material 610. The pattern wheel can be a cylinder having a texture embossed as a reverse pattern of a desired imprint on the construction material. The pattern wheel can also be rotationally suspended on connector 606 such that the corresponding imprint pattern can be progressively imprinted onto an incompletely cured surface of the construction material.

A 3D printer and finishing device which includes nozzles, such as those described above, can also be provided with a pattern wheel, such as pattern wheel 604, that can be oriented on the print head to engage the surface that has been printed. This pattern wheel may be smooth, textured or have an embossed pattern which transfers a decorative pattern to the printed surface. The pattern wheel can also comprise two rods that are disposed on either side of a printed surface, and that rotate as they move along the printed surface with the print head. In some applications water may be sprayed from the finishing device on the pattern wheel to keep the surface from adhering to the curable material.

In another example, the pattern wheel can be a textured cylinder. The pattern wheel may also be a smooth rod, or one or more rods, which engage the surface of the printed material to finish the surface. Water can be sprayed onto the rods as they rotate to reduce material transfer. This finishing can include adding texture or smoothing.

In another example, the pattern wheel can include rods, wheels, brushes, or cutting tools and surfaces. The pattern wheel may be moved along one or more additional axes to engage different portions of the surface which have been printed.

In another example the finishing unit may be a stamping device which presses in at intervals during printing and finishing.

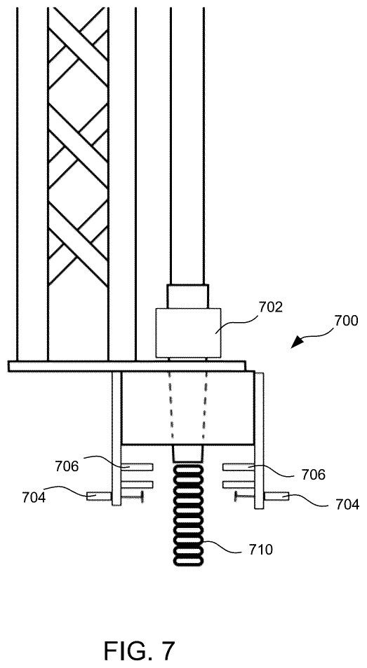

Referring to FIG. 7 a finishing device 700 can include a rotating device 702. The rotating device 702 can have a stamping device 704 that is operable to press in at intervals to modify the printed curable construction material 710. The finishing device 700 can also include nozzles 706.

The present technology also extends to a 3D printing finishing unit for use with three-dimensionally (3D) printed curable construction materials. The 3D printed curable construction materials can have multiple layers which are stacked and have respective sides. The finishing unit can include a finishing housing capable of being aligned with at least one side of the layers of the curable construction material. The finishing unit can include at least one nozzle to dispense a fluid. The fluid can be dispensed toward the surface of the at least one side of the layers. The fluid dispensed can modify the surface.

The 3D finishing unit can be independently constructed and implemented such that it can be suspended from any 3D printer. This finishing unit can include variable mounting pieces such that it can be utilized with any 3D printer which can print layered structures. In some examples the finishing unit can be entirely self-contained, needing only to be attached to a 3D printer for use. The finishing device can be attached to the print head, or to a separate element of a 3D printer, or to a separate device which would allow it to engage with the printed curable construction material.

Another aspect of the present application is a 3D printing finishing unit for use with any three-dimensionally printed curable construction materials. These materials may be extruded by any type of 3D printer that is capable of printing small or large items and structures. The materials extruded by 3D printers can result in multiple layers which are stacked and have sides which the finishing unit interacts with or finishes. This stacked material can be stacked vertically, horizontally, diagonally, or along any axis, and the finishing unit can be able to interact with the sides that are generally perpendicular to the orientation of the print head and the layers being extruded.

The finishing dispenser unit can include a finishing housing which may be aligned with at least one of the sides of the printed layers made of curable material. The finishing unit is then capable of using one or more nozzles to dispense fluids toward the surface of the side to modify the surface. This modification may occur on one or more layers simultaneously or may also occur on either side of the printed surface. Modifying one side of one layer with one nozzle via the finishing unit can help reduce the amount of time spent during or after printing finishing the surface by construction teams, and finishing multiple sides or layers simultaneously can provide further time savings.

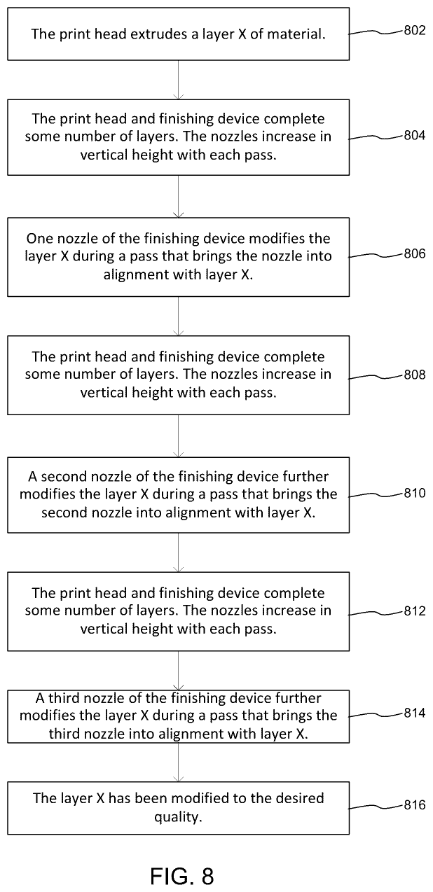

The present technology also extends to methods of finishing a three-dimensionally (3D) printed curable construction material. A method for finishing a 3D printed curable construction material is described below with reference to FIG. 8. The method can be performed using the systems and devices described above, including combinations thereof. The method can include extruding a layer of a curable construction material from a print head of a 3d printer as shown in step 802. In step 804, the 3d printer can print stacked layers of the curable construction material in a predetermined pattern via a print head suspended from a structural support. The 3D printer can print a predetermined number of layers increasing the height of a wall or structure being built with the curable construction material. As the 3d printer prints layers, the height of a print head of the 3d printer increases vertically. Nozzles of a finishing unit likewise can increase in vertical height with the print head.

In step 806, when a nozzle is aligned with one or more predetermined printed layers of the curable construction material, the nozzle modifies at least one side of the one or more printed layers via a finishing unit attached to the print head. The finishing unit can dispense a fluid from at least one nozzle toward the at least one side of a printed layer. When the finishing unit includes multiple nozzles, the method can continue with the print head laying additional layers, increasing in height vertically with each layer in step 808. In step 810, a second nozzle can become aligned with the one or more predetermined layers of the curable construction material and the second nozzle can further modify the one more predetermined layers of the curable construction material. If more nozzles are used in the finishing unit, this process can repeat as shown in steps 812 and 814.

In step 816, after the nozzles have each modified the one or more predetermined layers of curable construction material, the layers are modified to a desired quality. As mentioned above, the modification of the one or more layers of printed curable material can include flattening the side of each printed layer.

In the example above, there are two or more nozzles in a finishing unit. However, the finishing unit can comprise a single nozzle, a nozzle and stamping device, a nozzle and a brush roller, or any other number of finishing devices. In the above method, the nozzles are configured to progressively align with a given layer of the curable construction material as the print head rises vertically. However, multiple nozzles can also be operable to align with the same layer of the curable construction material.

The method can also incorporate other steps such as measuring a distance between a nozzle of the finishing unit and a side of the layers of the curable construction material. This can be done such as by using position sensors, image recognition sensors, RADAR, LIDAR, and the like. A flow rate of fluid emitted by the nozzles can be at least partially based on the measured distance. The method can also include actuating the nozzles into different positions relative to the curable construction material using actuators of the finishing unit. The actuating step can also be at least partially based on the measured distance between the nozzle and the layers of the curable construction materials.

In another example, the modification of the one or more layers of the curable construction material can include adding a surface finish additive. The surface finish additive can be added to the at least one side of the layers of the curable construction material via the fluid. The surface finish additive can include at least one of a color, sheen, texture, curing function, or sealant. In another example, the surface finish additive can include one or more of glitter, salt, iron, paint, or silica.

In another example, the print head can be a round print head. The print head can be used to dispense the curable construction material. In another example, the print head can be a rectangular print head. The print head can also be rotatable. In another example, the print head can be a split head. The split head can simultaneously dispense the curable construction material in adjacent layers. The adjacent layers can be spaced apart a gap distance. In another example, the curable construction material can be at least one or more of concrete, a geopolymer, geocrete, hempcrete, epoxy, foam, cement, cementitious materials, clay, mud, and concrete substitute.

### Flatwork and Slabs

In a further embodiment of the technology, the finishing device may be coupled with a larger print head which can dispense greater amounts of curable material at a time. This example of a finishing device can include trowels, bull-floats, Fresno trowels, and other tools for work on large, wide, horizontal surfaces.

An example of this may involve printing a large flat section of concrete, and then finishing the horizontal surface in what is termed “flatwork” or “laying a slab.” The finishing unit can assist in the leveling, smoothing, and ultimate finishing of flatwork and slabs, which can then allow the 3D printer to continue printing walls for a structure being built. Currently, flatwork is not typically completed with 3D printers due to the requirement of after-printing manual labor and typical 3D printers being oriented around vertical stacking of curable material, rather than horizontal layering or striping.

As a general guideline, interior print diameters can range from about 1 inch to 2 inches, and often about 1.5 inches. However, when printing flatwork the interior print diameter can be larger such as above about 2 inches to about 4 inches and in some cases up to about 6 inches.

In one embodiment, the finishing device might be a solid block of metal fitted around a hose end, which has been cut with channels forming the nozzle heads angled to blow at the different layers of cement. This would have air hoses of various strength attached to each channel, or one air hose which the channels redirect or amplify. This approach is similar to how a shower head has various openings which are angled to direct water in different directions or strengths.

In another embodiment, the nozzles may be on individual hoses which are positionable (like a Gorilla Grip positionable arm) or be on metal tubes that are shaped to put the nozzles at specific fixed angles, all of which are connected to a harness or attachment that is placed/affixed on the print head. The arms may be adjustable water sprayers such as those used on CNC metal cutting machines.

In another embodiment, the nozzles may be part of a larger assembly that attaches to the print head, which is able to modulate the pressure of the water or air going to each individual nozzle via valves, change the angle of each nozzle via servos or motors, and do so in real time via a computer controller to create more intricate patterns on the surface of the walls.

In another embodiment, the nozzles of the finishing device are connected to a reservoir or supply source which adds materials like glitter, sand, silica, salt, iron, etc. which are then emitted from the nozzles onto/into the surface.

The described features, structures, or characteristics may be combined in any suitable manner in one or more examples. In the preceding description numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well known structures or operations are not shown or described in detail to avoid obscuring aspects of the technology.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A three-dimensional (3D) printing and finishing device for forming and finishing a curable construction material to produce a 3D printed object, the 3D printing and finishing device comprising:
a structural support;
a print head suspended from the structural support and moveable along at least two axes with respect to the structural support, the print head configured to dispense the curable construction material in layers along a predetermined pattern to form the 3D printed object; and
a finishing unit attached to the print head, the finishing unit being disposed to align with at least one side of the layers of the curable construction material and being configured to dispense a fluid to modify a surface of the at least one side of the layers of the curable construction material, the finishing unit including at least one nozzle to dispense fluid toward the surface.

2. The 3D printing and finishing device of claim 1, wherein the at least one nozzle is configured to align with one or more of the layers of the curable construction material.

3. The 3D printing and finishing device of claim 2, wherein the at least one nozzle comprises two or more nozzles where each of the two or more nozzles are configured to align with one of the layers of the curable construction material.

4. The 3D printing and finishing device of claim 3, wherein the fluid is dispensed from each of the two or more nozzles to flatten the layers of the curable construction material with which the two or more nozzles are aligned.

5. The 3D printing and finishing device of claim 2, wherein each of the two or more nozzles are configured to vertically align with a corresponding plurality of uppermost dispensed layers of the curable construction material.

6. The 3D printing and finishing device of claim 1, wherein the fluid is dispensed from the nozzle to flatten a surface of the at least one side of the layers of the curable construction material.

7. The 3D printing and finishing device of claim 1, further comprising position sensors to measure a gap distance from the surface wherein a flow rate of the fluid dispensed by the finishing unit is at least partially based on feedback from the position sensors.

8. The 3D printing and finishing device of claim 7, wherein the finishing unit comprises one or more actuators to move the at least one nozzle relative to the surface, and wherein the one or more actuators are controlled based on the feedback from the position sensors.

9. The 3D printing and finishing device of claim 1, wherein the fluid comprises at least one of air and water.

10. The 3D printing and finishing device of claim 9, wherein the fluid further comprises a surface finish additive which provides at least one of a color, sheen, texture, curing function, or sealant to the at least one side of the layers of the curable construction material.

11. The 3D printing and finishing device of claim 10, wherein the surface finish additive comprises one or more of glitter, salt, iron, paint, or silica.

12. The 3D printing and finishing device of claim 1, wherein the print head is a round print head to dispense the curable construction material.

13. The 3D printing and finishing device of claim 1, wherein the print head is a rectangular print head and is rotatable along a vertical axis.

14. The 3D printing and finishing device of claim 1, wherein the print head comprises a split head that simultaneously dispenses the curable construction material in adjacent layers which are spaced apart a gap distance.

15. The 3D printing and finishing device of claim 1, wherein the curable construction material comprises at least one or more of concrete, a geopolymer, hempcrete, epoxy, foam, cement, cementitious materials, clay, mud, or concrete substitute.

16. The 3D printing and finishing device of claim 1, wherein the finishing unit further comprises a pattern wheel oriented to engage the surface and having an embossed pattern which transfers a decorative pattern to the surface.

17. The 3D printing and finishing device of claim 16, wherein the pattern wheel is a textured cylinder.

18. A 3D printing finishing unit for use with three-dimensionally printed curable construction materials having multiple layers which are vertically stacked and having respective sides, the finishing dispenser unit including a finishing housing capable of being aligned with at least one side of the layers of the curable construction material and at least one nozzle to dispense a fluid toward the surface to modify the surface of the at least one side of the layers of the curable construction material.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)
